(19) United States
(12) Patent Application Publication
(10) Pub. No.: US 2021/0126285 A1
(43) Pub. Date: Apr. 29, 2021

(54) NON-FLAMMABLE ELECTROLYTES

(71) Applicant: UChicago Argonne, LLC, Chicago, IL (US)

(72) Inventors: Guiliang Xu, Naperville, IL (US); Khalil Amine, Oakbrook, IL (US)

(21) Appl. No.: 16/660,968

(22) Filed: Oct. 23, 2019

(51) Int. Cl. H01M 10/0565; H01M 10/0567; H01M 10/0525

(52) U.S. Cl. CPC H01M 10/0565; H01M 10/0525; H01M 10/0567

(57) ABSTRACT

A lithium ion battery includes a lithium negative electrode, a positive electrode, a separator, and an electrolyte that includes a poly(alkyleneoxide) siloxane and a salt at a concentration of about 2 M to about 10 M. The concentration of the salt in the electrolyte is determined as mols of salt divided by volume of the electrolyte, without considering the volume change of the electrolyte due to dissolution of the salt, and is sufficiently high to suppress or prevent side reactions between the lithium metal and the electrolyte, thereby enabling a highly reversible lithium plating-stripping process to proceed.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to the electrolytes that are used in lithium metal batteries. In particular, the present technology describes electrolytes having high concentrations of a salt in the electrolyte to suppress dendrite formation.

### BACKGROUND

Lithium metal is the ultimate choice for the anode in a lithium ion battery, due to its high theoretical capacity (3,860 mAh/g, or 2,061 mAh/cm³) and low electrochemical potential (−3.04 V versus the standard hydrogen electrode), compared to other anode candidate materials. However, the lithium in the cell tends to deposit in dendritic form, which is known to be the main cause of thermal runaway and explosion hazards caused by internally shorting the cells. The solid electrolyte interphase (SEI) has become a critical component of battery research. Owing to the highly negative electrochemical potential of Li+/Li, virtually any available electrolyte can be reduced at the Li surface. Thus, electrolytes play a critical role on the formation of lithium dendrites.

Organic carbonates are typically the electrolyte solvent of choice for almost all commercial Li-ion batteries today, but they are not ideal for lithium metal cells. The initial SEI composition is mainly the product of lithium alkyl carbonates (ROC(O)OLi) by means of one-electron reduction of alkyl carbonates, which can be further converted to Li₂CO₃ in the presence of trace amounts of water (R is an alkyl group). Depending on the salts used, lithium halides, as well as large-molecular-weight polymers, can be present in the SEI. More stable components such as Li₂O, Li₂CO₃ and lithium halides dominate the inner layer of the SEI, while metastable ROC(O)OLi is distributed at the outer layer. The SEI can be further described by a ‘mosaic model’ formed by the heterogeneous stacking of small domains with distinct compositions.

Overall, SEIs of this type lack flexibility, making them vulnerable during interfacial fluctuation. Ethers are much better electrolyte solvents for lithium anodes, with higher Coulombic efficiency (>98%) and evident dendrite suppression achieved in several systems. This has been attributed to the formation of oligomers that show good flexibility and strong binding affinity to the lithium surface. However, ethers have been excluded from most commercial batteries, mainly owing to their low anodic decomposition voltage (<4 V vs Li+/Li) and high flammability.

### SUMMARY

In one aspect, a battery includes a lithium negative electrode; a positive electrode; a separator; and an electrolyte comprising: a poly(alkyleneoxide) siloxane; and a salt at a concentration of about 2 M to about 10 M; wherein: the concentration of the salt in the electrolyte is determined as mols of salt divided by volume of the electrolyte, without considering the volume change of the electrolyte due to dissolution of the salt. In any of the above embodiments, the concentration of the salt in the electrolyte may be from 2 M to 5 M. In any of the above embodiments, the concentration of the salt in the electrolyte may be from 6 M to 10 M.

In another aspect, a method of cycling the above battery includes discharging the battery. In another aspect, a method of cycling the above battery includes discharging the battery and charging the battery.

In another aspect, a battery includes a silicon negative electrode; a positive electrode; a separator; and an electrolyte comprising: a poly(alkyleneoxide) siloxane; and a salt at a concentration of about 2 M to about 10 M; wherein: the concentration of the salt in the electrolyte is determined as mols of salt divided by volume of the electrolyte, without considering the volume change of the electrolyte due to dissolution of the salt. In any of the above embodiments, the concentration of the salt in the electrolyte may be from 2 M to 5 M. In any of the above embodiments, the concentration of the salt in the electrolyte may be from 6 M to 10 M.

### BRIEF DESCRIPTION OF THE DRAWINGS

FIG. 1 is graph of the cycling performance (V vs. Time) of a Li|Li symmetric cell containing a dilute ether-based electrolyte at 1.25 mA/cm², where the total capacity was fixed at 1.25 mAh/cm², according to the examples.

FIG. 2 is a graph of the cycling performance of a Li|Li symmetric cell containing a concentrated siloxane-based electrolyte at 1.25 mAh/cm², where the total capacity was fixed at 1.25 mAh/cm², according to the examples.

FIG. 3A is the voltage profiles of amorphous silicon nanoparticles in concentrated siloxane based electrolytes at 420 mA g⁻¹ within 1.5-0.02V, according to the examples.

FIG. 3B is the voltage profiles of amorphous silicon nanoparticles in commercial carbonate based electrolytes at 420 mA g⁻¹ within 1.5-0.02V, according to the examples.

FIG. 3C is a comparison on the cycling performance of amorphous silicon nanoparticles in two electrolytes at 420 mA g⁻¹ within 1.5-0.02V, according to the examples.

FIG. 3D is the voltage profile for the 25^{th} cycle of amorphous silicon nanoparticles in two electrolytes at 420 mA g⁻¹ within 1.5-0.02V, according to the examples.

FIGS. 4A and 4B shows voltage profiles and cycle performance of Li/LiNi_{0.6}Co_{0.2}Mn_{0.2}O₂ cell at 18 mA g⁻¹ in concentrated siloxane-based electrolytes within 2.7-4.3V, according to Example 4.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

Described herein is a non-flammable, siloxane-based electrolyte for a lithium metal battery having lithium metal as an anode material, such that dendrite formation is suppressed or eliminated and/or reactions between the lithium and the electrolyte are suppressed or eliminated. The electrolytes include a high concentration lithium salt that has been surprisingly found to aid in the suppression of the lithium reactions and dendrite formation.

In one aspect, a battery is described that includes a lithium (Li) negative electrode, a positive electrode, and an electrolyte that includes a poly(alkyleneoxide) siloxane and a salt. In the electrolyte, the salt has a sufficiently high concentration to reduce the reactivity with the Li metal and enable reversible lithium stripping/plating. As noted above, side reactions of electrolyte materials and solvents having lower salt concentration with the lithium metal in batteries cause continuous SEI growth and lead to lithium dendrite formation. However, the electrochemical devices described herein, with the higher salt content in the electrolyte, have eliminated or at least minimized side reactions with lithium metal, leading to stabilization of the lithium metal batteries and improved performance.

The system provides a result that is surprising and unexpected. This is because solvation of the salt cations and/or anions would be expected to be enhanced if the salt concentration is increased. But increasing the concentration of electrolytes would lead to decrease of electronic conductivity and increase of viscosity, leading to a decrease in performance of the battery. Instead, and without being bound by the following theory, it is believed that the observed and actual improvement in performance is due to the concentrated salt electrolytes actually enhancing lithium ion solvation compared to conventional electrolytes. From a solvation structure point of view, a lithium ion (Lit) is normally coordinated with 3 to 4 solvent molecules in dilute electrolyte solutions. The solvation of the lithium ions is dominated by solvent-separated ion pairs (SSIPs) and free solvent molecules. Therefore, the SEI layer formed in regular electrolytes is mainly derived by the decomposition of electrolyte solvents. In the case of the concentrated electrolytes of the present application, the coordination number of the lithium is reduced to about 1 to 2, due to the scarcity of solvent molecules. Hence, as most of the solvent molecules are coordinated with the cations/anions, there is no free solvent that can react with Li metal or the counter electrodes in the lithium metal battery, which is beneficial to battery performance. Salt anions enter the solvation sheath to form contact ion pairs (CIPs) and cation-anion aggregates (AGGs). These salt anions participate in the SEI layer formation by shifting from a solvent decomposition to a salt anion decomposition/reaction as a result of the increase of Li salt concentration.

According to one embodiment, a battery is provided that includes a lithium negative electrode, a positive electrode, a separator, and an electrolyte. The electrolyte includes a poly(alkyleneoxide) siloxane having a salt at a concentration of about 2 M to about 10 M, where the concentration of the salt in the electrolyte is determined as mols of salt divided by volume of the electrolyte (in liters), without considering the volume change of the electrolyte due to dissolution of the salt.

The salt to be used in the electrolyte is not particularly limited, as long as it dissolves in the poly(ethyleneoxide) siloxane and serves as an electrolyte for a lithium metal battery, while preventing, or at least suppressing, the lithium dendrite formation. Illustrative salts, suited for use in a poly(ethyleneoxide) siloxane electrolyte of a lithium battery, include, but are not limited to, LiClO₄, LiPF₆, LiAsF₆, LiBF₄, LiB(C₂O₄)₂ (“LiBOB”), LiBF₂(C₂O₄) (“LiODFB”), LiCF₃SO₃, LiN(SO₂F)₂ (“LiFSI”), LiPF₃(C₂F₅)₃ (“LiFAP”), LiPF₄(CF₃)₂, LiPF₃(CF₃)₃, LiN(SO₂CF₃), LiCF₃CO₂, LiC₂F₅CO₂, LiPF₂(C₂O₄)₂, LiPF₄C₂O₄, LiN(CF₃SO₂)₂, LiC(CF₃SO₂)₃, LiN(SO₂C₂F₅)₂, a lithium alkyl fluorophosphate, Li₂B₁₂X₁₂-Ha, Li₂B₁₀X_{10-β}H_{β}, or a mixture of any two or more thereof, wherein X is OH, F, Cl, or Br; α is 0, 1, 2, 3, 4, 5, 6, 7, 8, 9, 10, 11, or 12; and β is 0, 1, 2, 3, 4, 5, 6, 7, 8, 9, or 10.

The concentration of the salt in the electrolytes may be, in any of the embodiments, from about 2 M to about 10 M in the electrolyte, where the molarity, M, is measured by moles of salt divided by the volume of the solvent without considering the volume change of the electrolyte composition after dissolving the salt. This concentration range include sub-ranges such as from about 2 M to about 9.5 M, about 2 M to about 8 M, about 2 M to about 7.5 M, about 2 M to about 7 M, about 2 M to about 6.5 M, about 2 M to about 6 M, about 2 M to about 5.5 M, about 2 M to about 5 M, about 2 M to about 4.5 M, about 2 M to about 4 M, about 2 M to about 3.5 M, about 2 M to about 3 M, or about 2 M to about 2.5 M. In some embodiments, the salt is present in the electrolyte at a concentration of about 2.5 M to about 10 M. This includes concentrations from about 2.5 M to about 9.5 M, about 2.5 M to about 9 M, about 2.5 M to about 2.5 M, about 2.5 M to about 8 M, about 2.5 M to about 7.5 M, about 2.5 M to about 7 M, about 2.5 M to about 6.5 M, about 2.5 M to about 6 M, about 2.5 M to about 5.5 M, about 2.5 M to about 5 M, about 2.5 M to about 4.5 M, about 2.5 M to about 4 M, about 2.5 M to about 3.5 M, or about 2.5 M to about 3 M. This includes concentrations from about 4 M to about 10 M, about 4 M to about 9 M, about 4 M to about 8 M, about 5 M to about 10 M, about 5 M to about 9 M, about 5 M to about 8 M, about 6 M to about 10 M, about 6 M to about 9 M, or about 6 M to about 8 M. In some embodiments, the salt is present in the electrolyte at a concentration of about 2.0 M, 2.5 M, 3.0 M, 3.5 M, 4.0 M, 4.5 M, 5.0 M, 5.5 M, 6.0 M, 6.5 M, 7.0 M, 7.5 M, 8.0 M, 8.5 M, 9.0 M, 9.5 M, or 10.0 M, including increments therein.

The poly(alkylene oxide) siloxanes (“PAO-siloxanes”) include siloxanes having at least one poly(alkylene oxide) (“PAO”) moiety on a silicon atom. In some embodiments, the poly(alkylene oxide) solvent is a compound of Formula I:

SiR¹₍₄₋ₓ₎(PAO)ₓ (I).

In Formula I, x is 1, 2, or 3 and each R¹ is independently hydrogen, a substituted or unsubstituted alkyl group having from 1 to 12 carbon atoms, a substituted or unsubstituted alkenyl group having from 2 to 12 carbon atoms, or a further siloxane group of Formula II:

OSiR²_{(3-x′)}(PAO)ₓ′ (II).

In Formula II, each R² is independently hydrogen, a substituted or unsubstituted alkyl group having from 1 to 12 carbon atoms, a substituted or unsubstituted alkenyl group having from 2 to 12 carbon atoms, or a further siloxane group of formula —OSiR²_{(2-x′)}(PAO)_{x′}, and x′ is 0, 1, 2, or 3. It will be understand that R¹ and/or R² may repeatedly be a further siloxane group, resulting in a polymeric siloxane. Such selection of x, x′, R′, and R² will be readily understood and determined by the person of ordinary skill in the art to form and terminate a polysiloxane. As used in any formula herein, a PAO may be a group of Formula III:

—{(CH₂)ₚ[O(CH₂)ₙ]_{q}(O)_{q′}R³} (III).

In Formula III, R³ is H, alkyl, or a group of Formula IV:

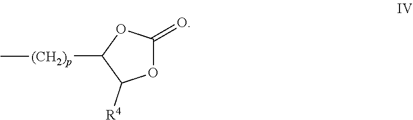

In Formula IV, n is an integer from 1 to 12; p is an integer from 0 to 12; q represents a polymeric repeat unit; q′ is 0 or 1; and R⁴ is H, alkyl, or alkenyl. Illustrative values of q may be from 1 to 1000. In some embodiments, this includes q being from 1 to 500, from 1 to 100, from 1 to 50, or from 1 to 10. In some embodiments, R³ is H or a C₁-C₁₂ alkyl. In other embodiments, R³ is methyl, ethyl, or propyl. In some embodiments, n is 1, 2, or 3. In some embodiments, p is 0, 1, 2, or 3. In any of the above embodiments, R⁴ is H, C₁-C₁₀ alkyl, or C₁-C₁₀ alkenyl. In any of the above embodiments, q may be 1, 2, 3, 4, 5, 6, 7, 8, 9, or 10.

In some embodiments, the PAO is a poly(ethylene oxide) or poly(propylene oxide) group. As a non-limiting example, the PAO may be a group of Formula III, where n is 2 or 3; p is 0, 1, 2, or 3; R³ is H, methyl, ethyl, propyl, or a group of Formula IV; and q is 1, 2, 3, 4, 5, 6, 7, 8, 9, or 10; and where R³ is a group of Formula IV, R⁴ is H, methyl, ethyl, or propyl. As noted above, selection of R¹ and R² may result in the formation of a polysiloxane that may then be terminated. To the extent a limit on the polysiloxane is required, no more than 100 groups of Formula II and/or III may be used in a compound of Formula I. Further, in various embodiments it may be that the upper limit for groups of Formula II and/or III that are in a compound of Formula I is 50, 25, 10, or 5.

Illustrative poly(ethyleneoxide) siloxanes include, but are not limited to (CH₃)₃SiCH₂O(CH₂CH₂O)ₙCH₃, (CH₃)₃Si(CH₂)₃O(CH₂CH₂O)ₙCH₃, (CH₃)₂Si[O(CH₂CH₂O)ₙCH₃]₂, CH₃Si[O(CH₂CH₂O)ₚCH₃]₃, Si[O(CH₂CH₂O)ₚCH₃]₄, (CH₃)₂Si[O(CH₂CH₂O)ₙCH₃][(CH₂)₃—O—(CH₂CH₂O)ₙCH₃], (CH₃)₃SiOR, (CH₃)₃Si(CH₂)₃OR, CH₃O(CH₂CH₂O)ₙSi(CH₃)₂OSi(CH₃)₂O(CH₂CH₂O)ₙCH₃, CH₃O(CH₂CH₂O)ₙSi(CH₃)₂OSi(CH₃)₂O(CH₂CH₂O)ₙCH₃, CH₃O(CH₂CH₂O)ₙCH₂Si(CH₃)₂OSi(CH₃)₂CH₂O(CH₂CH₂O)ₙCH₃, CH₃O(CH₂CH₂O)ₙ(CH₂)₃Si(CH₃)₂OSi(CH₃)₂(CH₂)₃O(CH₂CH₂O)ₙCH₃, (CH₃)₃SiOSi(CH₃)₂(CH₂)₃O(CH₂CH₂O)ₙCH₃, (CH₃)₃SiOSi(CH₃)₂(CH₂)₂O(CH₂CH₂O)ₙCH₃, (CH₃)₃SiOSi(CH₃)₂O(CH₂CH₂O)ₙCH₃, (CH₃)₃SiOSi(CH₃)₂OR, ROSi(CH₃)₂OSi(CH₃)₂OR, (CH₃)₃SiOSi(CH₃)₂(CH₂)₃OR, RO(CH₂)₃Si(CH₃)₂OSi(CH₃)₂(CH₂)₃OR, CH₃O(CH₂CH₂O)ₙSi(CH₃)₂OSi(CH₃)₂OSi(CH₃)₂O(CH₂CH₂O)ₙCH₃, CH₃O(CH₂CH₂O)ₙ′(CH₂)₃Si(CH₃)₂OSi(CH₃)₂OSi(CH₃)₂(CH₂)₃OSi(CH₃)₂O(CH₂CH₂O)ₙ′ CH₃, [(CH₃)₃SiO]₂Si(CH₃)O(CH₂CH₂O)ₙCH₃, [(CH₃)₃SiO]₂Si(CH₃)(CH₂)₃O(CH₂CH₂O)ₙCH₃, [(CH₃)₃SiO]₂Si(CH₃)O (CH₂CH₂O)ₙSi(CH₃) [OSi(CH₃)₃]₂, ROSi(CH₃)₂OSi(CH₃)₂OSi(CH₃)₂OR, ROSi(CH₃)₂OSi(CH₃)₂OSi(CH₃)₃, RO(CH₂)₃Si(CH₃)₂OSi(CH₃)₂OSi(CH₃)₂(CH₂)₃OR, RO(CH₂)₃Si(CH₃)₂OSi(CH₃)₂OSi(CH₃)₃, ROSi(CH₃)₂OSi(CH₃)₂OSi(CH₃)₂O(CH₂CH₂O)ₙCH₃, RO(CH₂)₃Si(CH₃)₂OSi(CH₃)₂OSi(CH₃)₂(CH₂)₃O(CH₂CH₂)ₙCH₃, or a mixture of any two or more such siloxanes. In such illustrative poly(ethyleneoxide) siloxanes R is a carbonate group; n is 2, 3, 4, 5, 6, or 7; n′ is 2, 3, 4, or 5; p is 2, 3, or 4; and p′ is 2 or 3. In some embodiments, the poly(ethyleneoxide) siloxane is 2,2-dimethyl-3,6,9-trioxa-2-siladecane (CH₃(OCH₂CH₂)₂OSi(CH₃)₃), 2,2-dimethyl-3,6,9,12-tetraoxa-2-silatridecane (CH₃(OCH₂CH₂)₃OSi(CH₃)₃), or a mixture thereof.

In some embodiments, the poly(alkyleneoxide) siloxane is 2,2-dimethyl-3,6,9-trioxa-2-siladecane (CH₃(OCH₂CH₂)₂OSi(CH₃)₃, or

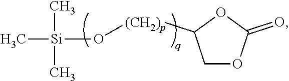

or a mixture thereof with any two or more of the siloxane herein, wherein p is 1, 2, 3, 4, 5, 6, 7, 8, 9, or 10; and q is 1, 2, 3, 4, 5, 6, 7, 8, 9, or 10. Alternatively, p may be 2, and q may be 1.

In the batteries described herein, and in any of the embodiments herein, the cathode may include a layered lithium nickel cobalt manganese oxide, spinel lithium nickel manganese oxide, lithium iron phosphates, lithium cobalt oxide, lithium nickel oxide, lithium manganese oxide, or a mixture of any two of more thereof. In other embodiments, the cathode ma include a layered lithium nickel cobalt manganese oxide, layered lithium nickel cobalt aluminum oxide, spinel lithium nickel manganese oxide, lithium iron phosphates, lithium cobalt phosphates, lithium manganese phosphates, lithium cobalt oxide, lithium nickel oxide, lithium manganese oxide, or a mixture of any two of more thereof.

Although the electrolytes are preferably poly(alkyleneoxide)siloxanes, some non-poly(alkyleneoxide)siloxanes may be used as a co-solvent to a concentration such that the inflammability of the electrolyte is not negatively impacted. For example, a non-poly(alkyleneoxide)siloxane may be included in the electrolyte from 0.01 vol % to about 80 vol %, wherein the vol % is calculated on the total volume of the at least one poly(alkyleneoxide) siloxane and co-solvents. The may include the co-solvent from about 1 vol % to about 70 vol %, from about 2 vol % to about 60 vol %, from about 3 vol % to about 50 vol %, or from about 4 vol % to about 40 vol %.

Non-poly(alkyleneoxide) siloxanes may also be used as co-solvents in the electrolytes. In some embodiments, the co-solvents are carbonated-based solvents. Illustrative carbonated-based co-solvents include, but are not limited to ethylene carbonate, dimethyl carbonate, ethyl methyl carbonate, diethyl carbonate, propylene carbonate, fluorinated carbonate, or a mixture of any two or more thereof. In some embodiments, the co-solvents are ether-based solvents. Illustrative ether-based co-solvents include, but are not limited to 1,3-dioxolane (“DOL”), dimethoxyethane (“DME”), tetrahydrofuran, di(ethylene glycol) dimethyl ether, tri(ethylene glycol) dimethyl ether, diglyme (DGM), partly silanized ether, tetra(ethylene glycol) dimethyl ether (“TEGDME”), poly (ethylene glycol) dimethyl ether (PEGDME), 1,4-dioxane, or a mixture of any two or more thereof. In some embodiments, the co-solvents are fluorinated ether-based solvents. Illustrative fluorinated ether-based co-solvents include, but are not limited to 1,1,2,2-tetrafluoroethyl-2,2,3,3-tetrafluoropropyl ether; 1,1,2,2-tetrafluoroethyl-2,2,3,3,3-pentafluoropropyl ether; 2,2,2-trisfluoroethyl-1,1,2,3,3,3-hexafluoropropyl ether; ethyl-1,1,2,3,3,3-hexafluoropropyl ether; difluoromethyl-2,2,3,3,3-pentafluoropropyl ether; difluoromethyl-2,2,3,3-tetrafluoropropyl ether; 2-fluoro-1,3-dioxolane; 2,2-difluoro-1,3-dioxolane; 2-trifluoromethyl-1,3-dioxolane; 2,2-bis(trifluoromethyl)-1,3-dioxolane; 4-fluoro-1,3-dioxolane; 4,5-difluoro-1,3-dioxolane, or a mixture of any two or more. In some embodiments, the co-solvents may be carbonated-based solvents, ether-based solvents, fluorinated ether-based solvents, dimethyl sulfoxide, sulfone, ionic liquids, or a mixture of any two or more thereof. In some embodiments, the co-solvent is 1, 1, 2, 2-tetrafluoroethyl-2, 2, 3, 3-tetrafluoropropyl ether. In some embodiments, the co-solvent is DOL.

The electrochemical device may further include stabilizing additives to extend the cycle life of the battery. Illustrative stabilizing additives include, but are not limited to N—O compounds, polysulfides, phosphorus pentasulfide, fumaronitrile, ethyl 3,3,3-trifluoropropanoate (TFPE), vinylene carbonate (VC), fluoroethylene carbonate (FEC), ethylene sulfite (ES), p-toluenesulfonyl isocyanate (PS TI), triethylborate (TEB), tris(trimethylsilyl)borate(TMSB), tris(trimethylsilyl)phosphite (TMSPi), tris(2,2,2-trifluoroethyl)phosphite (TTFPi), tris(trimethylsilyl)borate (TMSB), phenyl vinyl sulfone (PVS), ethylene glycol bis(propionitrile)ether (EGBE), terthiophene (3THP), quercetin (Qc), or a mixture of any two or more thereof. Illustrative N—O compounds include, but are not limited to inorganic nitrates, organic nitrates, inorganic nitrites, organic nitrites, organic nitro compounds, and other organic N—O compounds. In such embodiments, the stabilizing additives are present at a concentration of about 0.001 wt % to about 10 wt %.

In another aspect, an electrochemical device using a silicon anode is described as having a siloxane-based electrolyte having high concentration of a lithium salt as described above. The electrochemical device includes a cathode of a lithium-containing ceramic material as described herein, and an anode that includes silicon as an active agent, with the siloxane-based electrolyte as described in herein. Thus, in this further aspect, the change to the other aspects of the application is the use of silicon as the anode material. The form of the silicon may not be particularly limited and includes bulk silicon, micrometer sized silicon and nanoparticle size silicon. In one non-limiting illustration, it may be as silicon nanoparticles.

In this aspect, a battery includes a silicon negative electrode, a positive electrode comprising lithium, a separator; and an electrolyte, where in the electrolyte includes a poly(alkyleneoxide) siloxane, and a salt at a concentration of about 2 M to about 10 M, where the concentration of the salt in the electrolyte is determined as mols of salt divided by volume of the electrolyte, without considering the volume change of the electrolyte due to dissolution of the salt. In such batteries, the poly(alkyleneoxide) siloxane may be a compound of Formula I:

SiR¹₍₄₋ₓ₎(PAO)ₓ (I),

where x is 1, 2, or 3, PAO is a poly(alkyleneoxide) group, each R¹ is independently hydrogen, a substituted or unsubstituted alkyl group having from 1 to 12 carbon atoms, a substituted or unsubstituted alkenyl group having from 2 to 12 carbon atoms, or a further siloxane group of Formula II:

—OSiR²_{(3-x′)}(PAO)_{x′} (II);

each R² is independently hydrogen, a substituted or unsubstituted alkyl group having from 1 to 12 carbon atoms, a substituted or unsubstituted alkenyl group having from 2 to 12 carbon atoms, or a further siloxane group of Formula II, wherein no more than 50 R² in any compound of Formula I may repeat as Formula II; and x′ is 0, 1, 2, or 3. In some embodiments, the poly(alkyleneoxide) siloxane is group of Formula III:

—(CH₂)ₚ[O(CH₂)ₙ]_{q}(O)_{q′}R³ (III);

where R³ is H, alkyl, or a group of Formula IV

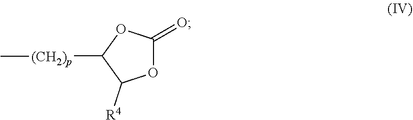

where n is an integer from 1 to 12, p is an integer from 0 to 12, q represents a polymeric repeat unit, q′ is 0 or 1, and R⁴ is H, alkyl, or alkenyl. In some embodiments, q is from 1 to 1000. In some embodiments, q is 1, 2, 3, 4, 5, 6, 7, 8, 9, or 10. In some embodiments, R³ is H or a C₁-C₁₂ alkyl. In some embodiments, R³ is methyl, ethyl, or propyl. In some embodiments, n is 1, 2, or 3. In some embodiments, p is 0, 1, 2, or 3. In some embodiments, R⁴ is H, C₁-C₁₀ alkyl, or C₁-C₁₀ alkenyl. In some embodiments, PAO is a poly(ethylene oxide) or a poly(propylene oxide) group. In some embodiments, n is 2 or 3; p is 0, 1, 2, or 3; R³ is H, methyl, ethyl, propyl, or a group of Formula IV; q is 1, 2, 3, 4, 5, 6, 7, 8, 9, or 10; R³ is a group of Formula IV; and R⁴ is H, methyl, ethyl, or propyl.

In this aspect, the poly(alkyleneoxide) siloxane may be (CH₃)₃SiO(CH₂CH₂O)ₙCH₃, (CH₃)₃SiCH₂O(CH₂CH₂O)ₙCH₃, (CH₃)₃Si(CH₂)₃O(CH₂CH₂C)_{n′}CH₃, (CH₃)₂Si[O(CH₂CH₂C)_{n′}CH₃]₂, CH₃Si[O(CH₂CH₂C)ₚCH₃]₃, Si[O(CH₂CH₂C)ₚ′CH₃]₄, (CH₃)₂Si[O(CH₂CH₂C)_{n′}CH₃][(CH₂)₃—O—(CH₂CH₂C)_{n′}CH₃], (CH₃)₃SiOR, (CH₃)₃Si(CH₂)₃OR, CH₃O(CH₂CH₂C)ₙSi(CH₃)₂OSi(CH₃)₂O(CH₂CH₂C)ₙCH₃, CH₃O(CH₂CH₂C)ₙSi(CH₃)₂OSi(CH₃)₂O(CH₂CH₂C)ₙCH₃, CH₃O(CH₂CH₂C)ₙCH₂Si(CH₃)₂OSi(CH₃)₂CH₂O(CH₂CH₂C)ₙCH₃, CH₃O(CH₂CH₂C)ₙ(CH₂)₃Si(CH₃)₂OSi(CH₃)₂(CH₂)₃O(CH₂CH₂C)ₙCH₃, (CH₃)₃SiOSi(CH₃)₂(CH₂)₃O(CH₂CH₂O)ₙCH₃, (CH₃)₃SiOSi(CH₃)₂(CH₂)₂O(CH₂CH₂C)ₙCH₃, (CH₃)₃SiOSi(CH₃)₂O(CH₂CH₂C)ₙCH₃, (CH₃)₃SiOSi(CH₃)₂OR, ROSi(CH₃)₂OSi(CH₃)₂OR, (CH₃)₃SiOSi(CH₃)₂(CH₂)₃OR, RO(CH₂)₃Si(CH₃)₂OSi(CH₃)₂(CH₂)₃OR, CH₃O(CH₂CH₂C)ₙSi(CH₃)₂OSi(CH₃)₂OSi(CH₃)₂O(CH₂CH₂C)ₙCH₃, CH₃O(CH₂CH₂O)ₙ′(CH₂)₃Si(CH₃)₂OSi(CH₃)₂OSi(CH₃)₂(CH₂)₃OSi(CH₃)₂O(CH₂CH₂O)_{n′}CH₃, [(CH₃)₃SiO]₂Si(CH₃)O(CH₂CH₂O)ₙCH₃, [(CH₃)₃SiO]₂Si(CH₃)(CH₂)₃O(CH₂CH₂C)ₙCH₃, [(CH₃)₃SiO]₂Si(CH₃)O (CH₂CH₂C)ₙSi(CH₃) [OSi(CH₃)₃]₂, ROSi(CH₃)₂OSi(CH₃)₂OSi(CH₃)₂OR, ROSi(CH₃)₂OSi(CH₃)₂OSi(CH₃)₃, RO(CH₂)₃Si(CH₃)₂OSi(CH₃)₂OSi(CH₃)₂ (CH₂)₃OR, RO(CH₂)₃Si(CH₃)₂OSi(CH₃)₂OSi(CH₃)₃, ROSi(CH₃)₂OSi(CH₃)₂OSi(CH₃)₂O(CH₂CH₂O)ₙCH₃, RO(CH₂)₃Si(CH₃)₂OSi(CH₃)₂OSi(CH₃)₂(CH₂)₃O(CH₂CH₂)ₙCH₃, or a mixture of any two or more such siloxanes; where R is a carbonate group; n is 2, 3, 4, 5, 6, or 7; n′ is 2, 3, 4, or 5; p is 2, 3, or 4; and p′ is 2 or 3.

In this aspect, the poly(alkyleneoxide) siloxane may be 2,2-dimethyl-3,6,9-trioxa-2-siladecane (CH₃(OCH₂CH₂)₂OSi(CH₃)₃) or

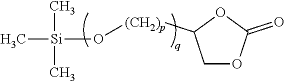

where p is 1, 2, 3, 4, 5, 6, 7, 8, 9, or 10; and q is 1, 2, 3, 4, 5, 6, 7, 8, 9, or 10. In some embodiments, p is 2 and q is 1.

In this aspect, the concentration of the salt in the electrolyte is from 2 M to 5 M. This may include where the concentration of the salt in the electrolyte is from 6 M to 10 M. In some embodiments, the electrolyte may also include a non-poly(ethyleneoxide) siloxane co-solvent.

In this aspect, the salt may be LiClO₄, LiPF₆, LiAsF₆, LiBF₄, LiB(C₂O₄)₂ (“LiBOB”), LiBF₂(C₂O₄) (“LiODFB”), LiCF₃SO₃, LiN(SO₂F)₂ (“LiFSI”), LiPF₃(C₂F₅)₃ (“LiFAP”), LiPF₄(CF₃)₂, LiPF₃(CF₃)₃, LiN(SO₂CF₃), LiCF₃CO₂, LiC₂F₅CO₂, LiPF₂(C₂O₄)₂, LiPF₄C₂O₄, LiN(CF₃SO₂)₂, LiC(CF₃SO₂)₃, LiN(SO₂C₂F₅)₂, a lithium alkyl fluorophosphate, Li₂B₁₂X_{12-α}H_{α}, Li₂B₁₀X_{10-β}H_{β}, or a mixture of any two or more thereof, wherein X is OH, F, Cl, or Br; a is 0, 1, 2, 3, 4, 5, 6, 7, 8, 9, 10, 11, or 12; and β is 0, 1, 2, 3, 4, 5, 6, 7, 8, 9, or 10.

In this aspect, positive electrode may include a layered lithium nickel cobalt manganese oxide, spinel lithium nickel manganese oxide, lithium iron phosphates, lithium cobalt oxide, lithium nickel oxide, lithium manganese oxide, or a mixture of any two of more thereof. In this aspect, the cathode may include a layered lithium nickel cobalt manganese oxide, layered lithium nickel cobalt aluminum oxide, spinel lithium nickel manganese oxide, lithium iron phosphates, lithium cobalt phosphates, lithium manganese phosphates, lithium cobalt oxide, lithium nickel oxide, lithium manganese oxide, or a mixture of any two of more thereof.

The present invention, thus generally described, will be understood more readily by reference to the following examples, which are provided by way of illustration and are not intended to be limiting of the present invention.

### Examples

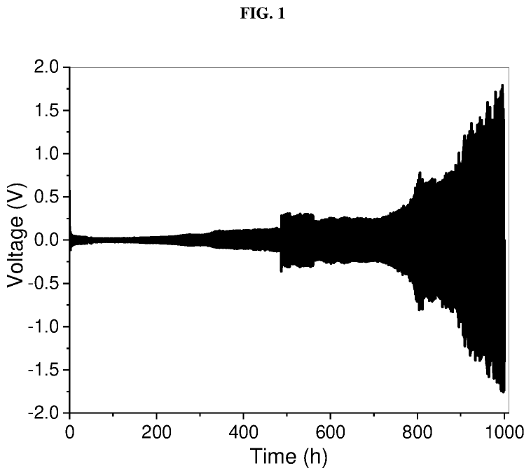

Example 1. FIG. 1 illustrates the cycling performance of a Li|Li symmetric cells containing ether-based electrolytes (1M LiTFSI and 0.1M LiNO₃ dissolved in mixture of 1,3-dioxolane and dimethoxyethane with a volume ratio of 1/1) at 1.25 mA/cm². The total capacity was fixed at 1.25 mAh/cm². As shown, the Li/Li symmetrical cell undergoes an increase in voltage polarization after 400 hours. The increase may be explained by the accumulation of SEI layers and dendrite structures.

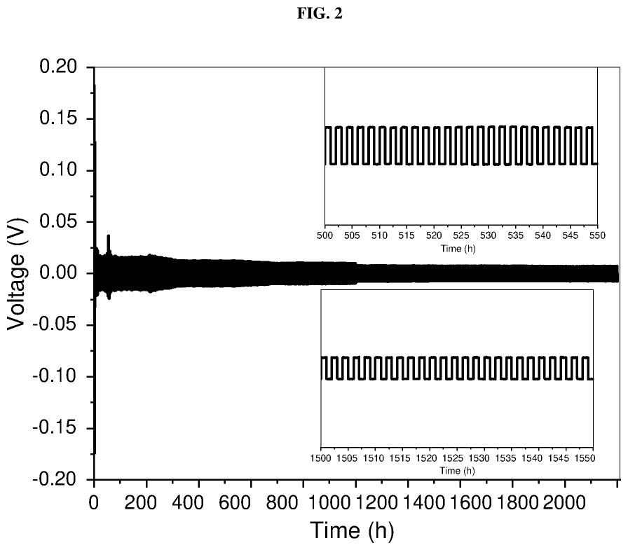

Example 2. FIG. 2 illustrates the cycling performance of a Li|Li symmetric cell at 1.25 mA/cm², the cell containing a concentrated siloxane-based electrolyte: 5M LiTFSI (lithium bis(trifluoromethanesulfonyl)imide) dissolved in a 1:1 vol:vol mixture of 1,3-dioxolane and 2,2-dimethyl-3,6,9-trioxa-2-siladecane. The total capacity was fixed at 1.25 mAh/cm². As shown, the cell cycled in the concentrated siloxane-based electrolyte demonstrated stable behavior for 2000 hours (1000 cycles) at a current density of 1.25 mA/cm², and with a voltage profile typical of a stable homogeneous lithium plating-stripping process. No lithium oxide dendrites formed. The lack of dendrite formation may be attributed to the suppressed parasitic reactions between lithium metal and concentrated siloxane-based electrolyte.

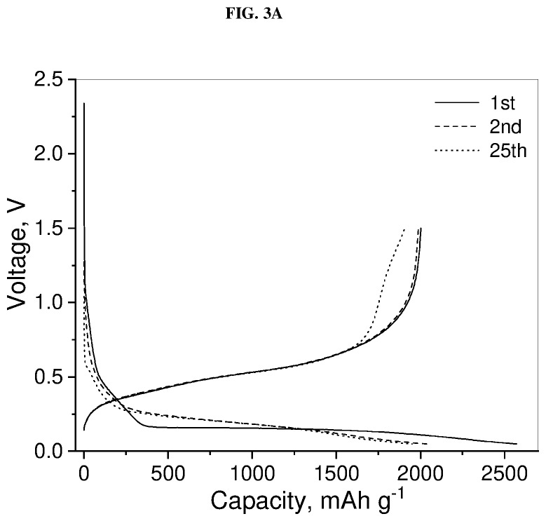

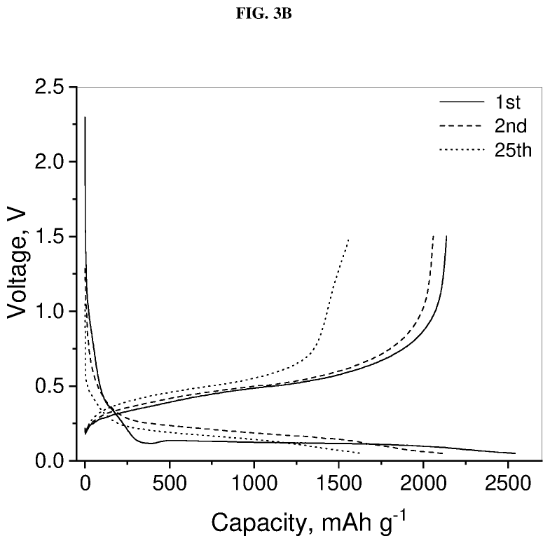

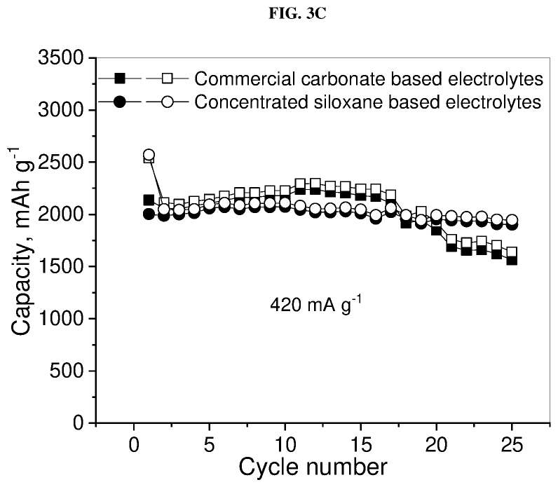

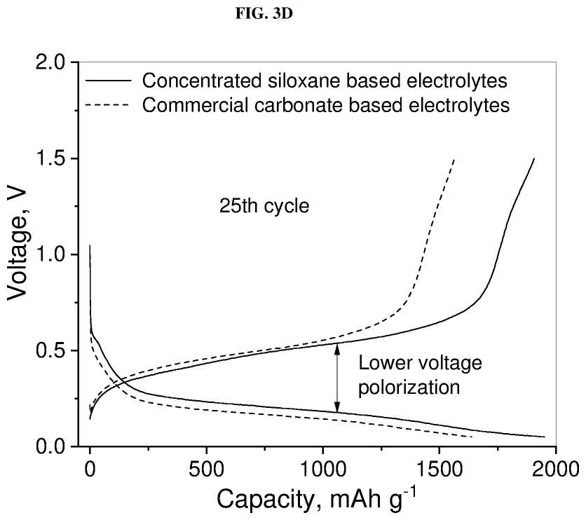

Example 3. The electrochemical performance of the above concentrated siloxane-based electrolyte was evaluated in a lithium metal/silicon battery, in which silicon is the most promising anode material (highest specific capacity) for lithium-ion battery and the working voltage of silicon down to 0.02 V. FIGS. 3A and 3B show the voltage profiles of amorphous silicon nanoparticles in concentrated siloxane-based, and carbonate-based, electrolytes at 420 mA/g in a voltage range of 1.5 to 0.02 V, respectively. FIG. 3C is a comparison in the cycling performance of amorphous silicon nanoparticles in two electrolytes at 420 mA/g in a voltage range of 1.5 to 0.02 V. FIG. 3D shows the voltage profile for the 25^{th} cycle of amorphous silicon nanoparticles in two electrolytes at 420 mA/g in a voltage range of 1.5 to 0.02 V. The results show that, when compared to the organic carbonate-based electrolytes, the Li/Si cell exhibits a more stable voltage profile, smaller voltage polarization, and better cycle stability in concentrated siloxane-based electrolytes. This is because the concentrated siloxane-based electrolytes can suppress the side reactions with lithium metal and enable a highly reversible lithium plating-stripping process.

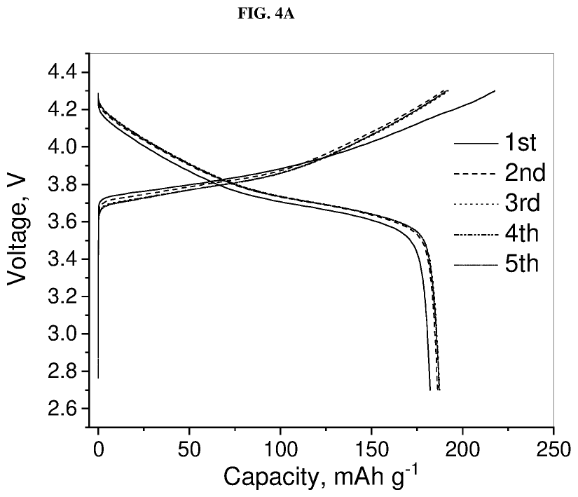

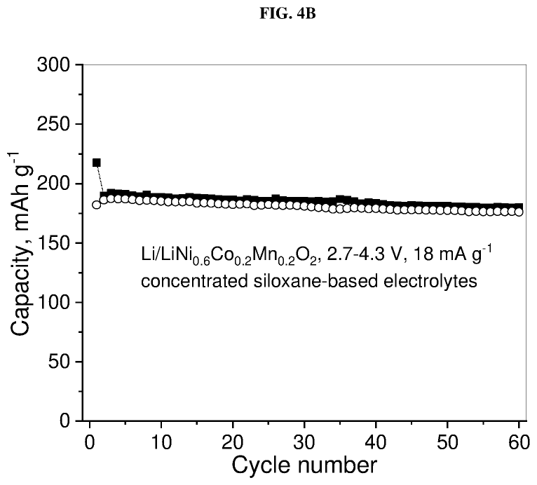

Example 4. The electrochemical performance of the above concentrated siloxane-based electrolytes in a lithium metal/LiNi_{0.6}Co_{0.2}Mn_{0.2}O₂ battery was also evaluated. In such batteries, LiNi_{0.6}Co_{0.2}Mn_{0.2}O₂ was the cathode material and a working voltage up to 4.3 V was used. FIGS. 4A and 4B shows voltage profiles and cycle performance of Li/LiNi_{0.6}Co_{0.2}Mn_{0.2}O₂ cell at 18 mA/g in the concentrated siloxane-based electrolytes within a voltage range of 2.7 to 4.3V. The results show that a Li/LiNi_{0.6}Co_{0.2}Mn_{0.2}O₂ cell exhibits both a stable voltage profile and good cycle stability, even when charged to 4.3 V. This indicates that the concentrated siloxane-based electrolytes have higher anodic decomposition voltage stability than ether-based electrolytes. The cell has an average working voltage of 3.7 V and reversible capacity of about 180 mAh/g, resulting in a high energy density of 666 Wh/kg. This has provided an approach to achieve the energy density goal of 500 Wh/kg for the next generation battery.

Example 5. In spite of the high energy density, the safety of lithium metal battery is a critical challenge for the practical application. The safety issues arise from the formation of lithium dendrites, which lead to internal shorting of the cell and thermal runaway. Another challenge is that the organic carbonates are flammable. The concentrated siloxane-based electrolytes have been shown exhibit suppressed lithium dendrite formation, and low flammability. In ignition testing of an ether based electrolyte and the siloxane-based electrolyte, the ether-based electrolyte ignited on the first attempt (flame from a butane lighting tool being touched to the surface of the electrolyte, while the concentrated siloxane-based electrolyte did not ignite after 20 attempts.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A battery comprising:
a lithium negative electrode;
a positive electrode;
a separator; and
an electrolyte comprising:
a poly(alkyleneoxide) siloxane; and
a salt at a concentration of about 2 M to about 10 M;
wherein:
the concentration of the salt in the electrolyte is determined as mols of salt divided by volume of the electrolyte, without considering the volume change of the electrolyte due to dissolution of the salt.

2. The battery of claim 1, wherein:
the poly(alkyleneoxide) siloxane is a compound of Formula I:
SiR¹₍₄₋ₓ₎(PAO)ₓ (I);
x is 1, 2, or 3; and
PAO is a poly(alkyleneoxide) group;
each R¹ is independently hydrogen, a substituted or unsubstituted alkyl group having from 1 to 12 carbon atoms, a substituted or unsubstituted alkenyl group having from 2 to 12 carbon atoms, or a further siloxane group of Formula II:
OSiR²_{(3-x′)}(PAO)_{x′} (II);
each R² is independently hydrogen, a substituted or unsubstituted alkyl group having from 1 to 12 carbon atoms, a substituted or unsubstituted alkenyl group having from 2 to 12 carbon atoms, or a further siloxane group of Formula II, wherein no more than 50 R² in any compound of Formula I may repeat as Formula II; and
x′ is 0, 1, 2, or 3.

3. The battery of claim 2, wherein the poly(alkyleneoxide) siloxane is group of Formula III:
—(CH₂)ₚ[O(CH₂)ₙ]_{q}(O)_{q′}R³ (III);
wherein:
R³ is H, alkyl, or a group of Formula IV 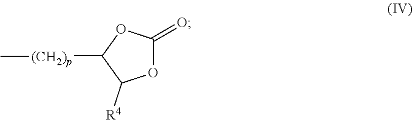
n is an integer from 1 to 12;
p is an integer from 0 to 12;
q represents a polymeric repeat unit;
q′ is 0 or 1; and
R⁴ is H, alkyl, or alkenyl.

4. The battery of claim 3, wherein q is from 1 to 1000.

5. The battery of claim 3, wherein q is 1, 2, 3, 4, 5, 6, 7, 8, 9, or 10.

6. The battery of claim 3, wherein R³ is H or a C₁-C₁₂ alkyl.

7. The battery of claim 6, wherein R³ is methyl, ethyl, or propyl.

8. The battery of claim 3, wherein n is 1, 2, or 3.

9. The battery of claim 3, wherein p is 0, 1, 2, or 3.

10. The battery of claim 3, wherein R⁴ is H, C₁-C₁₀ alkyl, or C₁-C₁₀ alkenyl.

11. The battery of claim 2, wherein PAO is a poly(ethylene oxide) or a poly(propylene oxide) group.

12. The battery of claim 3, wherein:
n is 2 or 3;
p is 0, 1, 2, or 3;
R³ is H, methyl, ethyl, propyl, or a group of Formula IV;
q is 1, 2, 3, 4, 5, 6, 7, 8, 9, or 10;
R³ is a group of Formula IV; and
R⁴ is H, methyl, ethyl, or propyl.

13. The battery of claim 1, wherein the poly(alkyleneoxide) siloxane is (CH₃)₃SiO(CH₂CH₂O)ₙCH₃, (CH₃)₃SiCH₂O(CH₂CH₂O)ₙCH₃, (CH₃)₃Si(CH₂)₃O(CH₂CH₂O)ₙCH₃, (CH₃)₂Si[O(CH₂CH₂O)_{n′}CH₃]₂, CH₃Si[O(CH₂CH₂O)ₚCH₃]₃, Si[O(CH₂CH₂O)ₚ—CH₃]₄, (CH₃)₂Si[O(CH₂CH₂O)ₙCH₃][(CH₂)₃—O—CH₂CH₂O)ₙCH₃], (CH₃)₃SiOR, (CH₃)₃Si(CH₂)₃OR, CH₃O(CH₂CH₂O)ₙSi(CH₃)₂OSi(CH₃)₂O(CH₂CH₂O)ₙCH₃, CH₃O(CH₂CH₂O)ₙSi(CH₃)₂OSi(CH₃)₂O(CH₂CH₂O)ₙCH₃, CH₃O(CH₂CH₂O)ₙCH₂Si(CH₃)₂OSi(CH₃)₂CH₂O(CH₂CH₂O)ₙCH₃, CH₃O(CH₂CH₂O)ₙ(CH₂)₃Si(CH₃)₂OSi(CH₃)₂(CH₂)₃O(CH₂CH₂O)ₙCH₃, (CH₃)₃SiOSi(CH₃)₂(CH₂)₃O(CH₂CH₂O)ₙCH₃, (CH₃)₃SiOSi(CH₃)₂(CH₂)₂O(CH₂CH₂O)ₙCH₃, (CH₃)₃SiOSi(CH₃)₂O(CH₂CH₂O)ₙCH₃, (CH₃)₃SiOSi(CH₃)₂OR, ROSi(CH₃)₂OSi(CH₃)₂OR, (CH₃)₃SiOSi(CH₃)₂(CH₂)₃OR, RO(CH₂)₃Si(CH₃)₂OSi(CH₃)₂(CH₂)₃OR, CH₃O(CH₂CH₂O)ₙSi(CH₃)₂OSi(CH₃)₂OSi(CH₃)₂O(CH₂CH₂O)ₙCH₃, CH₃O(CH₂CH₂O)_{n′}(CH₂)₃Si(CH₃)₂OSi(CH₃)₂OSi(CH₃)₂(CH₂)₃OSi(CH₃)₂O(CH₂C H₂O)ₙCH₃, [(CH₃)₃SiO]₂Si(CH₃)O(CH₂CH₂O)ₙCH₃, [(CH₃)₃SiO]₂Si(CH₃)(CH₂)₃O(CH₂CH₂O)ₙCH₃, [(CH₃)₃SiO]₂Si(CH₃)O (CH₂CH₂O)ₙSi(CH₃)[OSi(CH₃)₃]₂, ROSi(CH₃)₂OSi(CH₃)₂OSi(CH₃)₂OR, ROSi(CH₃)₂OSi(CH₃)₂OSi(CH₃)₃, RO(CH₂)₃Si(CH₃)₂OSi(CH₃)₂OSi(CH₃)₂ (CH₂)₃OR, RO(CH₂)₃Si(CH₃)₂OSi(CH₃)₂OSi(CH₃)₃, ROSi(CH₃)₂OSi(CH₃)₂OSi(CH₃)₂O(CH₂CH₂O)ₙCH₃, RO(CH₂)₃Si(CH₃)₂OSi(CH₃)₂OSi(CH₃)₂(CH₂)₃O(CH₂CH₂)ₙCH₃, or a mixture of any two or more such siloxanes;
wherein:
R is a carbonate group;
n is 2, 3, 4, 5, 6, or 7;
n′ is 2, 3, 4, or 5;
p is 2, 3, or 4; and
p′ is 2 or 3.

14. The battery of claim 1, wherein:
the poly(alkyleneoxide) siloxane is 2,2-dimethyl-3,6,9-trioxa-2-siladecane (CH₃(OCH₂CH₂)₂OSi(CH₃)₃) or 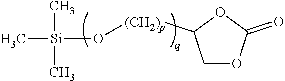
p is 1, 2, 3, 4, 5, 6, 7, 8, 9, or 10; and
q is 1, 2, 3, 4, 5, 6, 7, 8, 9, or 10.

15. The battery of claim 14, wherein p is 2, and q is 1.

16. The battery of claim 1, wherein the concentration of the salt in the electrolyte is from 6 M to 10M.

17. The battery of claim 1, wherein the electrolyte further comprises a non-poly(ethyleneoxide) siloxane co-solvent.

18. The battery of claim 1, wherein the salt comprises LiClO₄, LiPF₆, LiAsF₆, LiBF₄, LiB(C₂O₄)₂ (“LiBOB”), LiBF₂(C₂O₄) (“LiODFB”), LiCF₃SO₃, LiN(SO₂F)₂ (“LiFSI”), LiPF₃(C₂F₅)₃ (“LiFAP”), LiPF₄(CF₃)₂, LiPF₃(CF₃)₃, LiN(SO₂CF₃), LiCF₃CO₂, LiC₂F₅CO₂, LiPF₂(C₂O₄)₂, LiPF₄C₂O₄, LiN(CF₃SO₂)₂, LiC(CF₃SO₂)₃, LiN(SO₂C₂F₅)₂, a lithium alkyl fluorophosphate, Li₂B₁₂X_{12-α}H_{α}, Li₂B₁₀X_{10-β}H_{β}, or a mixture of any two or more thereof, wherein X is OH, F, Cl, or Br; α is 0, 1, 2, 3, 4, 5, 6, 7, 8, 9, 10, 11, or 12; and β is 0, 1, 2, 3, 4, 5, 6, 7, 8, 9, or 10.

19. The battery of claim 1, wherein the cathode comprises a layered lithium nickel cobalt manganese oxide, spinel lithium nickel manganese oxide, lithium iron phosphates, lithium cobalt oxide, lithium nickel oxide, lithium manganese oxide, or a mixture of any two of more thereof.

20. The battery of claim 1, wherein the cathode comprises a layered lithium nickel cobalt manganese oxide, layered lithium nickel cobalt aluminum oxide, spinel lithium nickel manganese oxide, lithium iron phosphates, lithium cobalt phosphates, lithium manganese phosphates, lithium cobalt oxide, lithium nickel oxide, lithium manganese oxide, or a mixture of any two of more thereof.
